(19) United States
(12) Patent Application Publication
(10) Pub. No.: US 2025/0368559 A1
(43) Pub. Date: Dec. 4, 2025

(54) GLASS FORMING APPARTUS HAVING A UNITARY STRUCTURE COMPRISING TIERED WEIR STRUCTURES FOR FORMING LAMINATED GLASS SHEETS

(71) Applicant: CORNING INCORPORATED, CORNING, NY (US)

(72) Inventors: Stephen Ayodeji Ajinola, Dacula, GA (US); Frank Coppola, Horseheads, NY (US); HungCheng Lu, Ithaca, NY (US); Steven Howard Tarcza, Painted Post, NY (US)

(21) Appl. No.: 19/223,916

(22) Filed: May 30, 2025

Related U.S. Application Data
(60) Provisional application No. 63/653,530, filed on May 30, 2024.
(60) Provisional application No. 63/654,541, filed on May 31, 2024.

(51) Int. Cl. C03B 17/06; C03B 17/02

(52) U.S. Cl. CPC C03B 17/061; C03B 17/02

(57) ABSTRACT

A forming apparatus including a forming member extending in a longitudinal direction with a first forming surface and a second forming surface converging downwardly along a draw line of the forming member, a first weir structure including a central wall extending upwardly from and longitudinally with the forming member, the central wall including a central channel opening vertically upward orthogonal to the longitudinal direction and extending between first and second sidewall portions of the central wall, and a second weir structure comprising first and second sidewalls extending upwardly from the forming member, the first and second sidewalls spaced apart from one another in a lateral direction orthogonal to the longitudinal and vertical directions, the central wall disposed between the first and second sidewalls to define a first channel between the first sidewall and the central wall and a second channel between the second sidewall and the central wall.

### CROSS REFERENCE TO RELATED APPLICATION

This application claims the benefit of priority under 35 U.S.C. § 119 of U.S. Provisional Application Ser. No. 63/654,541 filed on May 31, 2024, and claims the benefit of priority under 35 U.S.C. § 119 of U.S. Provisional Application Ser. No. 63/653,530 filed on May 30, 2024, the content of which is relied upon and incorporated herein by reference in its entirety their entireties.

### FIELD

The present disclosure generally relates to methods and apparatuses for forming glass sheets and, more specifically, to forming bodies and methods for forming continuous laminate glass ribbons having a plurality of glass layers.

### BACKGROUND

The fusion process is one technique for forming continuous glass ribbons. Compared to other processes for forming glass ribbons, such as the float and slot-draw processes, the fusion process produces glass ribbons with a relatively low number of defects and with surfaces having superior flatness. As a result, the fusion process is widely employed for the production of glass substrates used in the manufacture of LED and LCD displays and other substrates that require superior flatness. In the fusion process, molten glass is fed into a forming body, which includes forming surfaces that converge at a root. The molten glass evenly flows over the forming surfaces of the forming body and forms a ribbon of flat glass with pristine surfaces that is drawn from the root of the forming body.

Laminating a plurality of different glass compositions together to produce laminate glass sheets can provide different properties to glass sheets, such as improved strength or various optical properties. Laminate glass sheets have been made by a fusion process using double overflow forming bodies, which includes two or more overflow forming bodies arranged in a vertical relationship, each overflow forming body comprising two weirs over which the molten glass overflows. However, some double overflow forming body designs may limit the glass compositions that can be incorporated into the laminate glass sheets or have other challenges overcome by technology disclosed herein.

Accordingly, a need exists for alternative apparatuses and methods for producing continuous laminate glass ribbons using fusion process technology.

### SUMMARY

In a first aspect, a forming body for forming laminated glass sheets is disclosed comprising: a forming member extending in a longitudinal direction and comprising a first forming surface and a second forming surface converging downwardly along a draw line of the forming member; a first weir structure comprising a central wall extending upwardly from and longitudinally with the forming member, the central wall comprising a central channel opening upwardly in a vertical direction orthogonal to the longitudinal direction and extending longitudinally between first and second sidewall portions of the central wall, a second weir structure comprising first and second sidewalls extending upwardly from and longitudinally with the forming member, the first and second sidewalls spaced apart from one another in a lateral direction orthogonal to the longitudinal and vertical directions, the central wall disposed between the first and second sidewalls to define (i) a first channel between the first sidewall and the central wall and (ii) a second channel between the second sidewall and the central wall.

In a second aspect, one or more of the central wall or the central channel of the first aspect may be laterally aligned with a draw plane of the forming body.

In a third aspect, uppermost portions of the first and second sidewall portions of the first weir structure may define first and second weir surfaces, respectively, uppermost portions of the first and second sidewalls of the second weir structure define third and fourth weir surfaces, respectively, and the first and second weir surfaces may be disposed higher in the vertical direction than the third and fourth weir surfaces.

In the fourth aspect, the first and second weir surfaces of the third aspect may be disposed laterally inwardly from the third and fourth weir surfaces.

In a fifth aspect, the central wall of any one of the third or fourth aspects may comprise a thickness in the lateral direction that decreases from the first and second weir surfaces to the forming member.

In a sixth aspect, the first weir surface of the first weir structure of any one of the third aspect to the fifth aspect may comprise a laterally outermost edge overhanging the first channel of the second weir structure when viewed in the vertical direction.

In a seventh aspect, the second weir surface of the first weir structure of any one of the third aspect to the sixth aspect comprises a laterally outermost edge overhanging the second channel of the second weir structure when viewed in the vertical direction.

In an eighth aspect, each of the first and second channels of any one of the third to the seventh aspect comprises a bottom surface defined by the forming member.

In a ninth aspect, the central wall of the eighth aspect may comprise a first outer surface extending between the first weir surface and the bottom surface of the first channel, and a first angle between the first outer surface and the bottom surface is less than 90°.

In a tenth aspect, the central wall of any one of the eighth to the ninth aspect may comprise a second outer surface extending between the second weir surface and the bottom surface of the second channel, and a second angle between the second outer surface and the bottom surface is less than 90°.

In an eleventh aspect, the first sidewall of any one of the first to the tenth aspect may comprise a third outer surface intersecting the first forming surface, and the second sidewall may comprise a fourth outer surface intersecting the second forming surface.

In a twelfth aspect, the first and second channels of any one of the first to the eleventh aspects may comprise first and second widths, respectively, in the lateral direction, and the first and second widths are different.

In a thirteenth aspect, the first and second channels of any one of the first to the eleventh aspects may comprise first and second widths, respectively, in the lateral direction, and the first and second widths are the same.

In a fourteenth aspect, each of the first and second channels of any one of the first to the thirteenth aspects may comprise an inlet and an end dam spaced apart from one another in the longitudinal direction.

In a fifteenth aspect, the inlets and the end dams of the first and second channels of the fourteenth aspect are disposed, respectively, at the same end of the forming body.

In a sixteenth aspect, the inlets and the end dams of the first and second channels of the fourteenth aspect are disposed, respectively, at opposite ends of the forming body.

In a seventeenth aspect, a glass forming apparatus is disclosed, comprising: the forming body of any one of the first to the sixteenth aspects; a first glass delivery system in fluid communication with an inlet of the central channel; and a second glass delivery system in fluid communication with an inlet of the first channel, the second channel, or both.

In an eighteenth aspect, a method for forming a laminated glass ribbon comprising a plurality of glass layers is disclosed, comprising: flowing a first molten glass into a central channel of a first weir structure of a forming body, the forming body comprising a forming member extending in a longitudinal direction, the first weir structure comprising a central wall extending upwardly from and longitudinally with the forming member, the central wall comprising the central channel configured to open upwardly in a vertical direction orthogonal to the longitudinal direction and extending longitudinally between first and second sidewall portions of the central wall; passing the first molten glass over (i) the first sidewall portion to merge with a first portion of a first glass flow on a first side of the forming body and (ii) the second sidewall portion to merge with a second portion of the first glass flow on a second side of the forming body; flowing a second molten glass into at least one channel of a second weir structure of the forming body, the second weir structure comprising a pair of sidewalls extending upwardly from and longitudinally with the forming member and spaced apart from one another in a lateral direction orthogonal to the longitudinal and vertical directions, the central wall disposed laterally between the pair of sidewalls to define the at least one channel; passing the second molten glass over the at least one channel to merge with a second glass flow on a first side of the forming body, a second side of the forming body, or both; merging the second glass flow with the first glass flow to form a continuous laminate glass ribbon comprising a plurality of glass layers fused together; and drawing the continuous laminate glass ribbon downward from a draw line of the forming member.

In a nineteenth aspect, the merging of the eighteenth aspect may comprise merging the first glass flow with the second glass flow at the draw line.

In a twentieth aspect, the first molten glass of any one of the eighteenth to the nineteenth aspect may comprise a glass composition different from a glass composition of the second molten glass.

In a twenty-first aspect, the second glass flow of any one of the eighteenth to the twentieth aspect may form a core glass, and the first glass flow forms a clad glass.

In a twenty-second aspect, the at least one channel of any one of the eighteenth to twenty-first aspect may comprise (i) a first channel defined between a first sidewall of the pair of sidewalls and the central wall and (ii) a second channel defined between a second sidewall of the pair of sidewalls and the central wall.

In a twenty-third aspect method of the twenty-second aspect may further comprise: flowing the second molten glass into the first channel and the second channel; passing the second molten glass over the first sidewall to merge with a first portion of the second glass flow on the first side of the forming body; passing the second molten glass over the second sidewall to merge with a second portion of second glass flow on the second side of the forming body; and merging the first and second portions of the first glass flow with the first and second portions of the second glass flow at the draw line to form the continuous laminate glass ribbon comprising three glass layers fused together.

In a twenty-fourth aspect, the method of the twenty-second aspect may further comprise: flowing the second molten glass into the first channel; flowing a third molten glass into the second channel; passing the second molten glass over the first sidewall to merge with the second glass flow on the first side of the forming body; passing the third molten glass over the second sidewall to merge with a third glass flow on the second side of the forming body; merging the first and second portions of the first glass flow with both the second glass flow and the third glass flow at the draw line to form the continuous laminate glass ribbon comprising three glass layers fused together, wherein the first molten glass comprises a glass composition different from a glass composition of the second molten glass, and the third molten glass comprises a glass composition different from the glass compositions of the first and second molten glasses.

In a twenty-fifth aspect, uppermost portions of the first and second sidewall portions of the first weir structure of any one of the eighteenth aspect to the twenty-fourth aspect may define first and second weir surfaces, respectively, uppermost portions of the first and second sidewalls of the second weir structure of the eighteenth aspect of the twenty-fourth aspect define third and fourth weir surfaces, respectively, and the first and second weir surfaces may be disposed higher in the vertical direction than the third and fourth weir surfaces.

In a twenty-sixth aspect, a forming body for forming laminated glass sheets is disclosed, comprising: a forming member extending in a longitudinal direction and comprising a first forming surface and a second forming surface converging downwardly towards a draw line of the forming member; first and second sidewalls extending upwardly from and longitudinally with the forming member and spaced apart from one another in a lateral direction orthogonal to the longitudinal direction; a central wall extending upwardly from and longitudinally with the forming member, the central wall disposed between the first and second sidewalls to define (i) a first channel portioned between the first sidewall and the central wall and (ii) a second channel portion between the second sidewall and the central wall; and a conduit extending through the central wall and the forming member in a vertical direction orthogonal to the longitudinal and lateral directions and opening from the forming member to intersect the draw line, the conduit comprising a longest dimension aligned with the longitudinal direction.

In a twenty-seventh aspect, one or more of the central wall or the conduit of the twenty-sixth aspect may be laterally aligned with a draw plane of the forming body.

In a twenty-eighth aspect, the central wall of any one of the twenty-sixth to the twenty-seventh aspect may comprise a thickness in the lateral direction that increases from an upper surface of the central wall to the forming member.

In a twenty-ninth aspect, uppermost portions of the first and second sidewalls of the twenty-eighth aspect may define first and second weir surfaces, respectively, and wherein the upper surface of the central wall is disposed higher in the vertical direction than the first and second weir surfaces.

In a thirtieth aspect, the conduit of any one of the twenty-sixth to the twenty-ninth aspect may comprise a rectangular shape when viewed in a cross-section oriented normal to the vertical direction.

In a thirty-first aspect, the first sidewall of any one of the twenty-sixth aspect to the thirtieth aspect may comprise a first outer surface intersecting the first forming surface, and the second sidewall comprises a second outer surface intersecting the second forming surface.

In a thirty-second aspect, the first and second channel portions of any one of the twenty-sixth aspect to the thirty-first aspect may comprise first and second widths, respectively, in the lateral direction, and the first and second widths are different.

In a thirty-third aspect, the first and second channel portions of any one of the twenty-sixth aspect to the thirty-first aspect may comprise first and second widths, respectively, in the lateral direction, and the first and second widths are the same.

In a thirty-fourth aspect, each of the first and second channel portions of any one of the twenty-sixth aspect to the thirty-third aspect may comprise a bottom surface defined by the forming member.

In a thirty-fifth aspect, each of the first and second channel portions of any one of the twenty-sixth aspect to the thirty-fourth aspect may comprise an inlet and an end dam spaced apart from one another in the longitudinal direction.

In a thirty-sixth aspect, the inlets and the end dams of the first and second channel portions of the thirty-fifth aspect may be disposed, respectively, at the same end of the forming body.

In a thirty-seventh aspect, the inlets and the end dams of the first and second channel portions of the thirty-fifth aspect may be disposed, respectively, at opposite ends of the forming body.

In a thirty-eighth aspect, a glass forming apparatus is disclosed, comprising: the forming body of any one of the twenty sixth aspect to the thirty-seventh aspect; a first glass delivery system in fluid communication with an inlet of the conduit; and a second glass delivery system in fluid communication with an inlet of the first channel portion, the second channel portion, or both.

In a thirty-ninth aspect, a method for forming a laminated glass ribbon comprising a plurality of glass layers is disclosed, comprising: flowing a first molten glass into a conduit of a forming body, the forming body comprising (i) a forming member extending in a longitudinal direction and (ii) a central wall extending upwardly from and longitudinally with the forming member, the conduit extending through the central wall and the forming member in a vertical direction orthogonal to the longitudinal direction and opening from the forming member to intersect a draw line of the forming member, the conduit comprising a longest dimension aligned with the longitudinal direction; passing the first molten glass through the conduit to merge with a first glass flow at a bottom side of the forming body; flowing a second molten glass into at least one channel portion of the forming body, the forming body comprising a pair of sidewalls extending upwardly from and longitudinally with the forming member and spaced apart from one another in a lateral direction orthogonal to the longitudinal and vertical directions, the central wall disposed between the sidewalls to define the at least one channel portion; passing the second molten glass over at least one of the sidewalls to merge with a second glass flow on a first side of the forming body, a second side of the forming body, or both; merging the second glass flow with the first glass flow to form a continuous laminate glass ribbon comprising a plurality of glass layers fused together; and drawing the continuous laminate glass ribbon downward from the draw line.

In a fortieth aspect, the merging of the thirty-ninth aspect may comprise merging the first glass flow with the second glass flow at the draw line.

In a forty-fourth aspect, the first molten glass of the fourteenth or the fortieth aspect may comprise a glass composition different from a glass composition of the second molten glass.

In a forty-second aspect, the first glass flow forms a core glass, and the second glass flow of any one of the fourteenth to the forty-first aspect may form a clad glass.

In a forty-third aspect, the at least one channel portion of any one of the fourteenth to the forty-second aspect may comprise (i) a first channel portion defined between a first sidewall of the pair of sidewalls and the central wall and (ii) a second channel portion defined between a second sidewall of the pair of sidewalls and the central wall.

In a forty-fourth aspect, the forty-third aspect may further comprise: flowing the second molten glass into both the first channel portion and the second channel portion; passing the second molten glass over the first sidewall to merge with a first portion of the second glass flow on the first side of the forming body; passing the second molten glass over the second sidewall to merge with a second portion of second glass flow on the second side of the forming body; and merging the first glass flow with both the first portion of the second glass flow and the second portion of the second glass flow at the draw line to form the continuous laminate glass ribbon comprising three glass layers fused together.

In a forty-fifth aspect, the forty-third aspect may further comprise: flowing the second molten glass into the first channel portion; flowing a third molten glass into the second channel portion; passing the second molten glass over the first sidewall to merge with the second glass flow on the first side of the forming body; passing the third molten glass over the second sidewall to merge with a third glass flow on the second side of the forming body; merging the first glass flow with both the second glass flow and the third glass flow at the draw line to form the continuous laminate glass ribbon comprising three glass layers fused together, wherein the first molten glass comprises a glass composition different from a glass composition of the second molten glass, and the third molten glass comprises a glass composition different from the glass compositions of the first and second molten glasses.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 schematically depicts a laminate glass forming apparatus according to one or more aspects disclosed herein;

FIG. 2 schematically depicts a forming body provided as a reference for comparison to other forming body configurations disclosed herein;

FIG. 3 schematically depicts a perspective view of a forming body for use with the laminate glass forming apparatus of FIG. 1 according to one or more aspects disclosed herein;

FIG. 4 schematically depicts a top view of the forming body of FIG. 3;

FIG. 5 schematically depicts an axial cross section of the forming body taken along line A-A in FIG. 4;

FIG. 6 reproduces and simplifies the view of FIG. 5 to show dimensions of some features of the forming body; and

FIG. 7 shows the axial cross section of FIG. 5 with a plurality of molten glasses distributed by the forming body according to one or more aspects disclosed herein;

FIG. 8 schematically depicts a perspective view of another forming body for use with the laminate glass forming apparatus of FIG. 1 according to one or more aspects disclosed herein;

FIG. 9 schematically depicts a top view of the forming body of FIG. 8;

FIG. 10 schematically depicts a bottom view of the forming body of FIG. 8;

FIG. 11 schematically depicts a longitudinal cross section of the forming body of FIG. 8 taken along line B-B;

FIG. 12 schematically depicts an axial cross section of the forming body of FIG. 8 taken along line C-C;

FIG. 13 shows the axial cross section of FIG. 12 with a first configuration of molten glass distributed by the forming body according to one or more aspects disclosed herein;

FIG. 14 shows the axial cross section of FIG. 12 with a second configuration of molten glass distributed by the forming body according to one or more aspects disclosed herein; and

FIG. 15 shows the axial cross section of FIG. 12 with a third configuration of molten glass distributed by the forming body according to one or more aspects disclosed herein.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, the sub ranges such as from 1-3, from 2-4, from 3-5, etc., as well as 1, 2, 3, 4, and 5 individually. The same principle applies to ranges reciting only one numerical value as a minimum or maximum. Furthermore, such an interpretation should apply regardless of the breadth of the range or the characteristics being described by the range.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

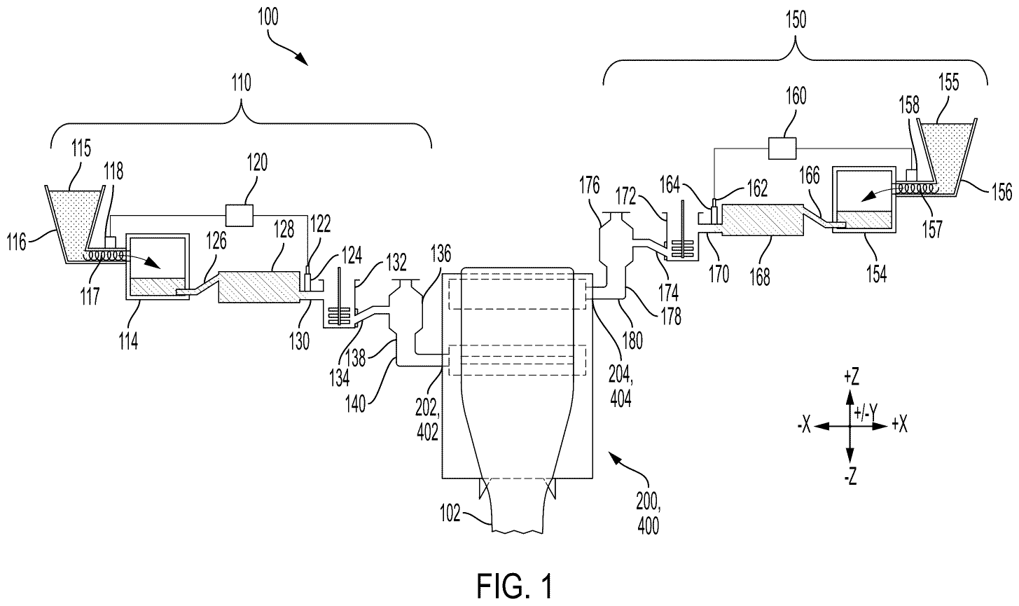

Referring to FIG. 1, the glass forming apparatus 100 and forming body 200 disclosed herein may be employed to produce continuous laminate glass ribbons 102 for making laminate glass sheets. Continuous laminate glass ribbons 102 and laminate glass sheets made therefrom may include a plurality of glass layers, such as 2, 3, 4, 5, 6, or more than 6 layers of glass. In some embodiments, the continuous laminate glass ribbon 102 may include a core glass layer and at least two clad glass layers, where the core glass layer is disposed between the two clad glass layers. Each of the layers of glass may be fused together. In some embodiments, one or more of the glass layers may have a different glass composition than the other glass layers. The different glass compositions in the different glass layers may have different properties, such as coefficients of thermal expansion (CTE), Young's modulus, optical properties, chemical resistance, or other properties, which may provide certain features, such as improved strength, modified optical properties, or other features, to the laminated glass sheets produced from the continuous laminate glass ribbons 102.

The glass forming apparatus 100 may generally include a first molten glass delivery system 110 and a second molten glass delivery system 150. The first molten glass system 110 may be in fluid communication with a first inlet 202 of the forming body 200 and may be operable to deliver a first molten glass 209 to the first inlet 202 of the forming body 200. The second molten glass system 150 may be in fluid communication with a second inlet 204 of the forming body 200 and may be operable to deliver a second molten glass 210 to the second inlet 204 of the forming body 200.

The first molten glass system 110 may include a first melting vessel 114 that receives a first batch material 115 from a first storage bin 116. The first batch material 115 can be introduced to the first melting vessel 114 by a first batch delivery device 117 powered by a motor 118. An optional first controller 120 may be provided to activate the motor 118 and a first molten glass level probe 122 can be used to measure the glass melt level within a first standpipe 124 and communicate the measured information to the first controller 120. The first molten glass system 110 can also include a first fining vessel 128, such as a fining tube, coupled to the first melting vessel 114 by way of a first connecting tube 126. A first mixing vessel 132 may be coupled to the first fining vessel 128 with a second connecting tube 130. A first delivery vessel 136 may be coupled to the first mixing vessel 132 with a first delivery conduit 134. As further illustrated, a first downcomer 138 may be coupled to the first delivery vessel 136 and may be operable to deliver glass melt from the first delivery vessel 136 to a first delivery tube 140 in fluid communication with the first inlet 202 of the forming body 200.

The second molten glass system 150 may include a second melting vessel 154 that receives a second batch material 155 from a second storage bin 156. The second batch material 155 can be introduced to the second melting vessel 154 by a second batch delivery device 157 powered by a motor 158. An optional second controller 160 may be provided to activate the motor 158, and a second molten glass level probe 162 can be used to measure the glass melt level within a second standpipe 164 and communicate the measured information to the second controller 160. The second molten glass system 150 can also include a second fining vessel 168, such as a fining tube, coupled to the second melting vessel 154 by way of a third connecting tube 166. A second mixing vessel 172 may be coupled to the second fining vessel 168 with a fourth connecting tube 170. A second delivery vessel 176 may be coupled to the second mixing vessel 172 with a second delivery conduit 174. As further illustrated in FIG. 1, a second downcomer 178 may be coupled to the second delivery vessel 176 and may be operable to deliver glass melt from the second delivery vessel 176 to second delivery tube 180 in fluid communication with the second inlet 204 of the forming body 200.

The first melting vessel 114, the second melting vessel 154, or both, are typically made from a refractory material, such as refractory (e.g., ceramic) brick. The glass forming apparatus 100 may further include components that can be made from electrically conductive refractory metals such as, for example, platinum or platinum-containing metals such as platinum-rhodium, platinum-iridium, and combinations thereof. Such refractory metals may also include molybdenum, palladium, rhenium, tantalum, titanium, tungsten, ruthenium, osmium, zirconium, and alloys thereof and/or zirconium dioxide. The platinum-containing components can include, but are not limited to, one or more than one of the first connecting tube 126, the first fining vessel 128, the second connecting tube 130, the first standpipe 124, the first mixing vessel 132, the first delivery conduit 134, the first delivery vessel 136, the first downcomer 138, the first delivery tube 140, the third connecting tube 166, the second fining vessel 168, the fourth connecting tube 170, the second standpipe 164, the second mixing vessel 172, the second delivery conduit 174, the second delivery vessel 176, the second downcomer 178, the second delivery tube 180, or combinations of these.

Referring to FIG. 1, in operation, the first batch material 115, specifically batch material for forming glass, is fed from the first storage bin 116 into the first melting vessel 114 with the first batch delivery device 117. The first batch material 115 is melted into a first molten glass in the first melting vessel 114. The first molten glass passes from the first melting vessel 114 into the first fining vessel 128 through the first connecting tube 126. Dissolved gasses, which may result in glass defects, are removed from the first molten glass in the first fining vessel 128. The first molten glass then passes from the first fining vessel 128 into the first mixing vessel 132 through the second connecting tube 130. The first mixing vessel 132 homogenizes the first molten glass, such as by stirring, and the homogenized first molten glass passes through the first delivery conduit 134 to the first delivery vessel 136. The first delivery vessel 136 discharges the homogenized first molten glass through first downcomer 138 and into the first delivery tube 140 in fluid communication with the first inlet 202 of the forming body 200.

Similarly, the second batch material 155, also specifically batch material for forming glass, is fed from the second storage bin 156 into the second melting vessel 154 with the second batch delivery device 157. The second batch material 155 is melted into a second molten glass in the second melting vessel 154. The second molten glass passes from the second melting vessel 154 into the second fining vessel 168 through the third connecting tube 166. Dissolved gasses, which may result in glass defects, are removed from the second molten glass in the second fining vessel 168. The second molten glass then passes from the second fining vessel 168 into the second mixing vessel 172 through the fourth connecting tube 170. The second mixing vessel 172 homogenizes the second molten glass, such as by stirring, and the homogenized second molten glass passes through the second delivery conduit 174 to the second delivery vessel 176. The second delivery vessel 176 discharges the homogenized second molten glass through second downcomer 178 and into the second delivery tube 180 in fluid communication with the second inlet 204 of the forming body 200. Operation of the forming body 200 will be described in further detail later in this Description.

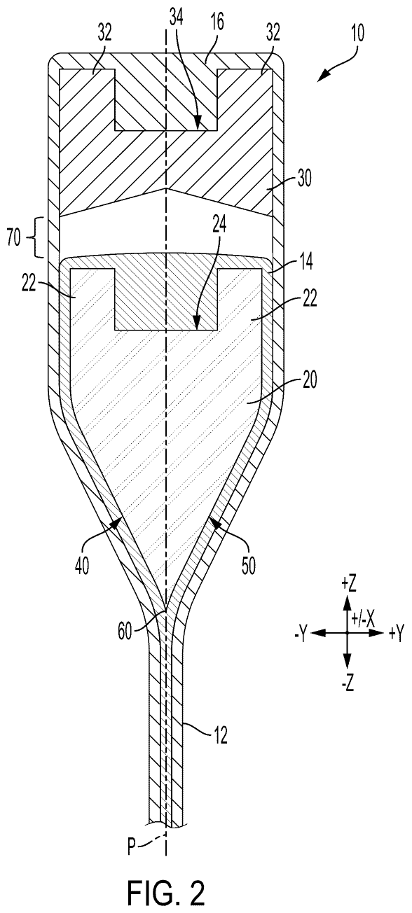

Referring now to FIG. 2, a forming apparatus 10 comprising double overflow forming bodies for producing a laminate fusion glass ribbon 12 is schematically depicted for comparison to other embodiments disclosed herein. The forming apparatus 10 generally includes a first overflow body 20, a second overflow forming body 30 positioned above and vertically aligned with first overflow forming body 20, a first forming surface 40, and a second forming surface 50. First overflow forming body 20 may be similar in shape and function to a single forming body for making a single-layer fusion-draw glass ribbon. First overflow forming body 20 includes a pair of first weirs 22 that define a first trough 24 therebetween. First forming surface 40 and second forming surface 50 extend from the first overflow forming body in a vertically downward direction (i.e., the −Z direction of the coordinate axes depicted in FIG. 2) and converge towards one another, joining at a lower (bottom) edge of double overflow apparatus 10, which may also be referred to as root 60. In operation, a molten core glass 14 may be passed into first trough 24 of first overflow forming body 20. The molten core glass 14 may overflow first weirs 22 and flow down (i.e., in the −Z direction of the coordinate axis of FIG. 2) first forming surface 40 and second forming surface 50 in two separate flows of molten core glass 14. The two separate flows of molten core glass 14 may converge at root 60 and fuse together to form a core layer of laminate fusion glass ribbon 12.

Second overflow forming body 30 is spaced apart from first overflow forming body 20 and includes a pair of second weirs 32 that define a second trough 34. The second overflow forming body 30 differs from first overflow forming body 20 in that second overflow forming body 30 does not include converging forming surfaces that converge at a root. Instead, the separate molten glass flows from second overflow forming body 30 free fall downward (i.e., in the −Z direction of the coordinate axis of FIG. 2) from the outer surface of second overflow forming body 30 into contact with molten core glass 14. In operation, a molten clad glass 16 may be passed into second trough 34 of second overflow forming body 30. The molten clad glass 16 may overflow second weirs 32 and flow vertically downward (i.e., in the −Z direction) along the outer surfaces of second overflow forming body 30 in two separate flows of molten glass. At gap 70 between first overflow forming body 20 and second overflow forming body 30, the two separate molten glass flows of molten clad glass 16 freefall downward (i.e., −Z direction) across the gap and onto the two separate molten glass flows of molten core glass 14. Each of the flows of molten clad glass 16 fuse with a flow of molten core glass 14 and continue down first forming surface 40 and second forming surface 50, respectively, to root 60. Molten clad glass 16 forms the clad layer of laminate fusion glass ribbon 12 at root 60. Laminate fusion glass ribbon 12 may be drawn from root 60 on draw plane P in a vertically downward direction (i.e., in the −Z direction of the coordinate axis of FIG. 2) by pulling rolls (not shown). Laminate fusion glass ribbon 12 may be further processed downstream of forming apparatus 10, such as by segmenting laminate fusion glass ribbon 12 into discrete glass sheets, rolling the laminate fusion glass ribbon 12 upon itself, and/or applying one or more coatings to glass ribbon 12.

The forming apparatus 10 may enable formation of the laminate fusion glass ribbon 12 having a plurality of glass layers. However, such a forming body as shown in FIG. 2, comprising the double overflow forming bodies as shown may require a very precise positioning system for first overflow forming body 20 and second overflow forming body 30 relative to each other to provide uniform thickness of all three layers of laminate fusion glass ribbon 12. Additionally, instability of free falling molten clad glass 16 across gap 70 between second overflow forming body 30 and first overflow forming body 20 may lead to variations in the thickness of one or more of the glass layers and/or the overall thickness of laminate fusion glass ribbon 12 and the laminate glass sheets produced therefrom in some such designs.

By contrast, forming body 200 disclosed herein overcomes such deficiencies in forming apparatus 10 to provide greater consistency in the thicknesses of individual glass layers and overall thickness of continuous laminate glass ribbon 102. The forming body disclosed herein may also provide for a wider range of glass compositions to be incorporated into continuous laminate glass ribbon 102.

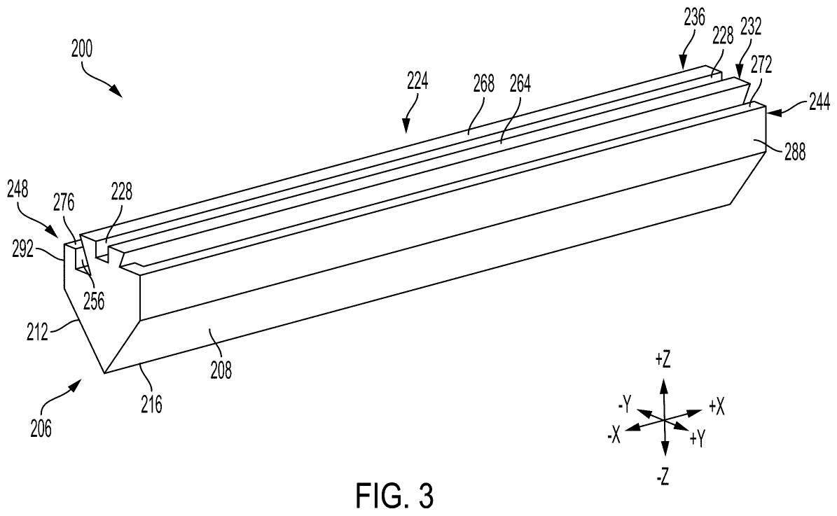

Referring now to FIGS. 3-6, forming body 200 disclosed herein comprises a forming member 206 with a wedge-like cross-sectional shape that extends in a longitudinal direction (e.g., along the +/−X direction of the coordinate axis in FIGS. 3-6). Forming member 206 comprises a first forming surface 208 and a second forming surface 212 that converge downwardly (e.g., the forming surfaces extend with a directional component in the −Z direction) towards a draw line 216 of the forming member. As used herein, the “draw line” comprises the line along which first and second forming surfaces 208, 212 physically converge or intersect.

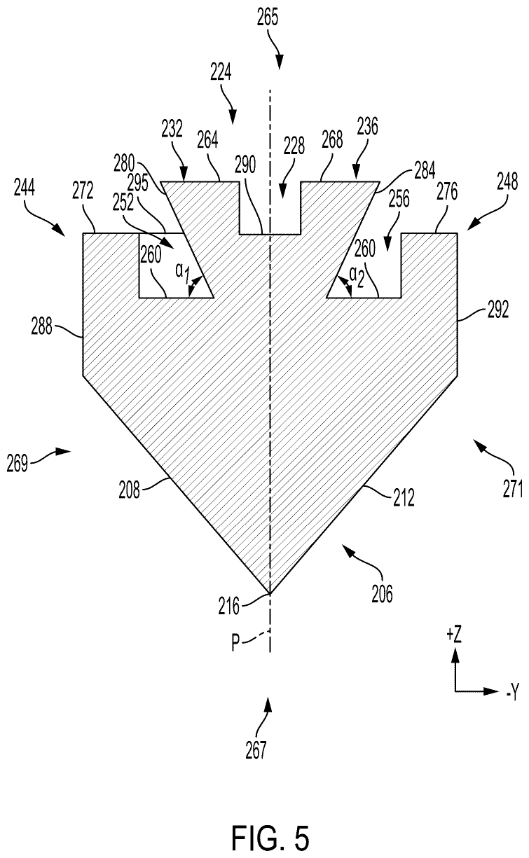

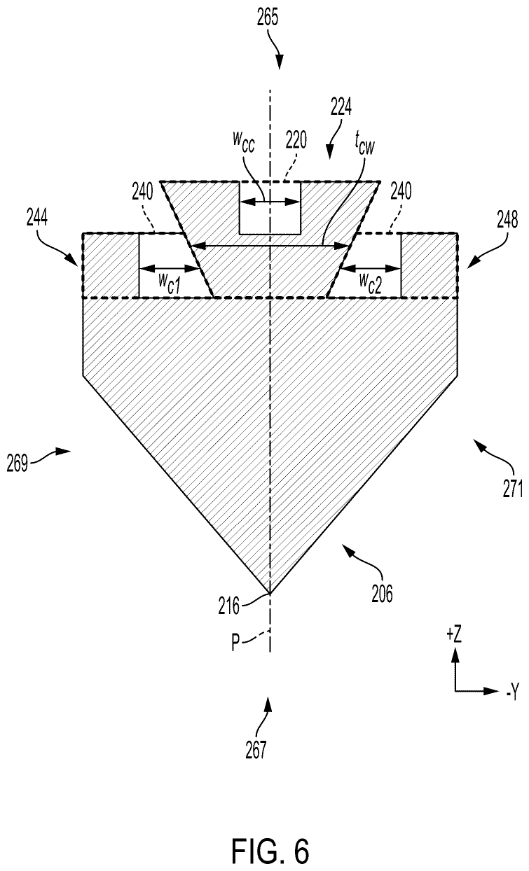

Forming body 200 further comprises a first weir structure (e.g., dashed boundary 220 in FIG. 6) comprising a central wall 224 that extends upwardly (e.g., in the +Z direction or having a directional component in the +Z direction) from and longitudinally (e.g., in or substantially in the longitudinal direction) with forming member 206. It should be appreciated that dashed boundary 220 illustrating the first weir structure is not a physical boundary separating the first weir structure from the unitary structure of forming body 200. The central wall 224 comprises a central channel 228 that opens upwardly in a vertical direction (e.g., along the +/−Z direction of the coordinate axis in FIGS. 3-6) orthogonal to the longitudinal direction and extends longitudinally between a first sidewall portion 232 and a second sidewall portion 236 of central wall 224. In aspects, one or more of central wall 224 and central channel 228 are laterally aligned with a draw plane P (FIG. 5) of forming body 200. In aspects, one or more of central wall 224 and central channel 228 are symmetric about draw plane P. As shown in FIG. 5, draw plane P generally bisects draw line 216 in the +/−Y directions of the coordinate axes depicted in FIG. 3-6 and extends in the vertically downward direction (e.g., −Z direction) and in the +/−X direction.

Forming body 200 further comprises a second weir structure (e.g., dashed boundary 240 in FIG. 6) comprising a first sidewall 244 and a second sidewall 248 that extend upwardly from and longitudinally with forming member 206. It should be appreciated that dashed boundary 240 illustrating the second weir structure is not a physical boundary separating the second weir structure from the unitary structure of forming body 200. The first and second sidewalls 244, 248 are spaced apart from one another in a lateral direction (e.g., along the +/−Y direction of the coordinate axis in FIGS. 3-6) that is orthogonal to the longitudinal and vertical directions. Central wall 224 of first weir structure 220 is disposed between (e.g., laterally between) first and second sidewalls 244, 248 to define at least one channel 252, 256. In aspects, the at least one channel comprises a first channel 252 defined between first sidewall 244 and central wall 224. In aspects, the at least one channel (additionally or alternatively) comprises a second channel 256 defined between second sidewall 248 and central wall 224. First and second channels 252, 256 are disposed above (e.g., vertically, directly above) forming member 206 such that forming member 206 defines a bottom surface 260 of each of first and second channels 252, 256.

In aspects, uppermost portions of first sidewall portion 232 and second sidewall portion 236 of first weir structure 220 define a first weir surface 264 and a second weir surface 268, respectively. In aspects, uppermost portions of first sidewall 244 and second sidewall 248 of second weir structure 240 define a third weir surface 272 and a fourth weir surface 276, respectively. In aspects, as best shown in FIG. 5, first and second weir surfaces 264, 268 of first weir structure 220 are disposed higher in the vertical direction than third and fourth weir surfaces 272, 276 of second weir structure 240.

In aspects, as best shown in FIG. 5, first and second weir surfaces 264, 268 are disposed laterally inwardly from (e.g., closer to the draw plane P than) third and fourth weir surfaces 272, 276 of second weir structure 240. In aspects, central wall 224 comprises a thickness t_{cw} in the lateral direction that decreases from first and second weir surfaces 264, 268 to forming member 206. In such aspects, first weir surface 264 of first weir structure 220 comprises a laterally outermost (e.g., farthest from the draw plane P) edge that overhangs first channel 252 of second weir structure 240 when viewed in the vertical direction. Similarly, in such aspects, second weir surface 268 of first weir structure 220 comprises a laterally outermost edge that overhangs second channel 256 of second weir structure 240 when viewed in the vertical direction.

In aspects, as best shown in FIG. 5, central wall 224 comprises a first outer surface 280 that extends between first weir surface 264 and bottom surface 260 of first channel 252. In such aspects, a first angle a₁ between first outer surface 280 and bottom surface 260 is less than 90°, such as 88°, 86°, 84°, 82°, 80°, 78°, 74°, 70°, 66°, 62°, 58°, 54°, 50°, 46°, or less, and comprising all sub-ranges and/or sub-values between and comprising these values. In aspects, central wall 224 comprises a second outer surface 284 that extends between second weir surface 268 and bottom surface 260 of first channel 252. In such aspects, a second angle a₂ between second outer surface 284 and bottom surface 260 is less than 90°, such as 88°, 86°, 84°, 82°, 80°, 78°, 74°, 70°, 66°, 62°, 58°, 54°, 50°, 46°, or less, and comprising all sub-ranges and/or sub-values between and comprising these values. In aspects, first sidewall 244 comprises a third outer surface 288 that intersects first forming surface 208. In aspects, second sidewall 248 comprises a fourth outer surface 292 that intersects second forming surface 212.

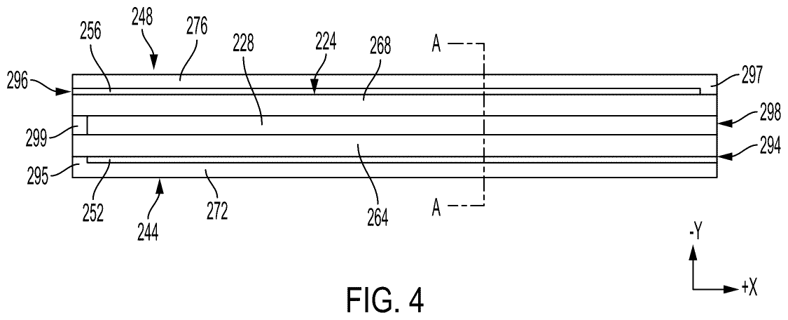

As shown in FIG. 6, first channel 252 comprises a first width w_{c1} in the lateral direction, and second channel 256 comprises a second width w_{c2} in the lateral direction. In some aspects, first and second widths w_{c1}, w_{c2} are different. In other aspects, first and second widths w_{c1}, w_{c2} are the same. When comparing dimensions of first and second channels 252, 256 (e.g., first and second widths w_{c1}, w_{c2}), the dimensions are measured from the same reference position for each feature. For example, the width of each channel can be measured (e.g., in a measurement direction) from a position on an inner surface of the sidewall that is (i) a specific distance in the vertical direction from a first reference feature or surface (e.g., bottom surface 260) and (ii) a specific distance in the longitudinal direction from a second reference feature or surface (e.g., an end dam 295, 297 of forming body 200, as shown in and described with reference to FIG. 4). In aspects, first and second widths w_{c1}, w_{c2} can be constant or variable in one or more directions.

As shown in FIG. 6, central channel 228 comprises a channel width w_{cc} in the lateral direction. In aspects, channel width w_{cc} can be constant or variable in one or more directions. In aspects, channel width w_{cc} can be less than, greater than, or equal to first width w_{c1} of first channel 252 and/or second width w_{c2} of second channel 256.

In aspects, as shown in FIG. 4, first channel 252 comprises a first inlet 294 (e.g., a first inlet end or side) and a first end dam 295 spaced apart from first inlet 294 in longitudinal direction. First inlet 294 and first end dam 295 bound first channel 252 in the longitudinal direction, first sidewall 244 and central wall 224 bound first channel 252 in the lateral direction, and bottom surface 260 defined by forming member 206 bounds first channel 252 in the downward direction (e.g., −Z direction) such that molten glass delivered (e.g., delivered continuously) to first channel 252 moves upwardly within (e.g., fills) first channel 252 and flows over third weir surface 272 and down third outer surface 288.

In aspects, as shown in FIG. 4, second channel 256 comprises a second inlet 296 (e.g., a second inlet end or side) and a second end dam 297 spaced apart from second inlet 296 in the longitudinal direction. First inlet 296 and first end dam 297 bound second channel 256 in the longitudinal direction, second sidewall 248 and central wall 224 bound second channel 256 in the lateral direction, and bottom surface 260 defined by forming member 206 bounds second channel 256 in the downward direction (e.g., −Z direction) such that molten glass delivered (e.g., delivered continuously) to second channel 256 moves upwardly within (e.g., fills) second channel 256 and flows over fourth weir surface 276 and down fourth outer surface 292.

In aspects, first and second inlets 294, 296 can be disposed at a first (same) end of forming body 200, and first and second end dams 295, 297 can be disposed at a second (same) end of forming body 200. In such aspects, first and second channels 252, 256 can be configured to receive molten glass from the same glass delivery system and/or receive the same composition of molten glass from the same glass delivery system. In such aspects, first and second end dams 295, 297 can be configured as a common end dam (not shown).

In aspects, as shown in FIG. 4, first and second inlets 294, 296 can be disposed at different ends of forming body 200, and first and second end dams 295, 297 can be disposed at different ends of forming body 200. For example, first inlet 294 can be disposed at first end and second inlet 296 can be disposed at the second end. Similarly, first end dam 295 can be disposed at the second end and second end dam 297 can be disposed at the first end. In such aspects, first and second channels 252, 256 can be configured to received molten glass from different glass delivery systems and/or receive different compositions of molten glass from the different glass delivery systems.

In aspects, as shown in FIG. 4, central channel 228 comprises a central inlet 298 (e.g., an inlet end or side) and a central end dam 299 spaced apart from central inlet 298 in the longitudinal direction. Central inlet 298 and central end dam 295 bound central channel 228 in the longitudinal direction, first sidewall portion 232 and second sidewall portion 236 bound central channel 228 in the lateral direction, and a bottom surface 290 defined by central wall 224 bounds central channel 228 in the downward direction (e.g., −Z direction) such that molten glass delivered (e.g., delivered continuously) to central channel 228 moves upwardly within (e.g., fills) central channel 228 and flows over (i) first weir surface 264 and free-falls downwardly (e.g., in the −Z direction or having a directional component in the −Z direction) from the laterally outermost edge of first weir surface 264 towards first channel 252 and (ii) second weir surface 268 and free-falls downwardly (e.g., in the −Z direction or having a directional component in the −Z direction) from the laterally outermost edge of second weir surface 268 towards second channel 256.

In aspects, forming body 200 is a unitary structure in which forming member 206, first weir structure 220, and second weir structure 240 or portions thereof are (i) formed from a single bulk volume of material such that there are no distinguishable microstructural boundaries therebetween and/or (ii) joined along major corresponding surfaces using joining techniques (e.g., welding) that cause cross-boundary material interdiffusion that provides a permanent joint therebetween.

The various features of forming body 200 described herein can be constructed of a refractory metal capable of withstanding the temperatures experienced during formation of continuous laminate glass ribbon 102 without degrading or reacting with the constituents of first molten glass 209 or second molten glass 210. The refractory metal can be platinum, platinum alloy, or other metals or metal alloys. In aspects, one or more of forming member 206, first weir structure 220, and second weir structure 240 can be platinum or a platinum-alloy. Central channel 228 and first and second channels 252, 256 can also be platinum or a platinum-alloy since these features can be defined by forming member 206, first weir structure 220, and/or second weir structure 240. All-platinum or platinum alloy surfaces of forming body 200 can reduce or prevent compatibility issues between the glass compositions and refractory materials used for overflow-style forming bodies.

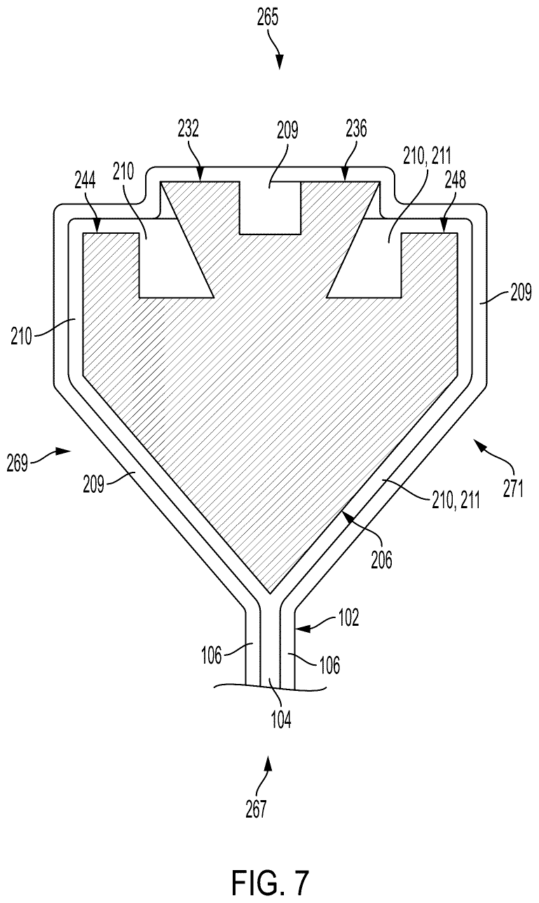

A method for forming a laminated glass ribbon having a plurality of glass layers is now described with reference to FIG. 7, which depicts a plurality of molten glasses distributed by forming body 200 of FIGS. 3-6. The method comprises flowing first molten glass 209 into a central channel 228 of first weir structure 220 of forming body 200. As previously described with reference to FIG. 1, first molten glass 209 can be produced in first molten glass system 110 (FIG. 1) and delivered to central channel 228 via one of inlets 202, 204 to forming body 200. First molten glass 209 can be flowed into central channel 228 via central inlet 298 at an end (e.g., longitudinal end) of central channel 228 and/or at top side 265 (FIG. 5) of forming body 200.

As previously described with reference to FIGS. 3-6, \ forming body 200 comprises \ forming member 206 extending in a longitudinal direction (e.g., +/−X direction). First weir structure 220 comprises central wall 224 that extends upwardly from and longitudinally with forming member 206. Central wall 224 comprises central channel 228 configured to open upwardly in a vertical direction (e.g., +/−Z direction) that is orthogonal to the longitudinal direction and extend longitudinally between first sidewall portion 232 and second sidewall portion 236 of central wall 224.

The method further comprises passing first molten glass 209 over first sidewall portion 232 to merge with a first portion of a first glass flow on first side 269 (FIGS. 5-7) of forming body 200. The method further comprises passing first molten glass 209 over second sidewall portion 236 to merge with a second portion of the first glass flow on second side 271 (FIGS. 5-7) of forming body 200.

While first molten glass 209 is flowed into central channel 228 and passed over first and second sidewall portions 232, 236, the method further comprises flowing second molten glass 210 into at least one channel 252, 256 of second weir structure 240 of forming body 200. As previously described with reference to FIG. 1, second molten glass 210 can be produced in second molten glass system 150 (FIG. 1) and delivered to the at least one channel 252, 256 via one of inlets 202, 204 to forming body 200.

As previously described with reference to FIGS. 3-6, second weir structure 240 comprises a pair of sidewalls (e.g., first and second sidewalls 244, 248) that extend upwardly from and longitudinally with forming member 206. Sidewalls 244, 248 are spaced apart from one another in a lateral direction (e.g., +/−Y direction) that is orthogonal to the longitudinal and vertical directions. Central wall 224 of first weir structure 220 is disposed laterally between sidewalls 244, 248 to define the at least one channel 252, 256.

The method further comprises passing second molten glass 210 over at least one of sidewalls 244, 248 to merge with a second glass flow on first side 269 of forming body 200, second side 271 of the forming body, or both. As shown in FIG. 7, the second glass flow of second molten glass 210 flows from the at least one channel (e.g., first channel 252 and/or second channel 256 shown in FIGS. 3-6), over at least one of the weir surfaces of sidewalls 244, 248 (e.g., third and fourth weir surfaces 272, 280 shown in FIGS. 3-6), downwardly along at least one of the outer surfaces of sidewalls 244, 248 (e.g., third and fourth outer surfaces 288, 292), and downwardly along at least one of the forming surfaces of forming member 206 (e.g., first and second forming surfaces 208, 212).

While first molten glass 209 is flowed into central channel 228 and passed over first and second sidewall portions 232, 236 and second molten glass 210 is flowed into the at least one channel portion 252, 256 and passed over the at least one of sidewalls 244, 248, the method further comprises merging the second glass flow with the first glass flow to form a continuous laminate glass ribbon 102 having a plurality of glass layers 104, 106 fused together.

For example, upon contact at or proximate draw line 216, the flow of second molten glass 210 may fuse to the flow of first molten glass 209. The flow of second molten glass 210 can form core layer 104 of continuous laminate ribbon 102. The flow of first molten glass 209 can form clad layers 106 of continuous laminate glass ribbon 102. In aspects, core layer 104 of second molten glass 210 can be disposed between two clad layers 106 of first molten glass 209, as shown in FIG. 7. In aspects, first molten glass 209 comprises a glass composition that is different from a glass composition of second molten glass 210. In aspects, first and second molten glasses 209, 210 can have the same glass composition.

After the first and second glass flows are merged (e.g., at draw line 216) to form continuous laminate glass ribbon 102, the method can comprise drawing continuous laminate glass ribbon 102 downward from draw line 216 of forming member 203.

In aspects, the at least one channel comprises a first channel 252 defined between a first sidewall 244 of pair of sidewalls 244, 248 and central wall 224. In aspects, the at least one channel also comprises a second channel 256 defined between a second sidewall 248 of the pair of sidewalls 244, 248 and central wall 224. In such aspects, flowing second molten glass 210 into the at least one channel 252, 256 comprises (i) flowing second molten glass 210 into first channel 252 and second channel 256, (ii) passing second molten glass 210 over first sidewall 244 to merge with a first portion of the second glass flow on first side 269 of forming body 200, (iii) passing second molten glass 210 over second sidewall 248 to merge with a second portion of second glass flow on second side 271 of forming body 200, and (iv) merging the first and second portions of the first glass flow of first molten glass 209 with the first and second portions of the second glass flow of second molten glass 210 at draw line 216 to form continuous laminate glass ribbon 102 having three glass layers fused together.

In aspects in which second molten glass 210 is flowed into first channel 252 and second channel 256 of second weir structure 240, the merging comprises merging the first portion of the first glass flow of first molten glass 209 with the first portion of the second glass flow of second molten glass 210 on the first side in a first region disposed vertically between first weir surface 264 and third weir surface 272. For example, as shown in FIG. 7, the first portion of the first glass flow of first molten glass 209 flows from central channel 228, over first weir surface 264 of first sidewall portion 232, and then free-falls downwardly (e.g., in the −Z direction or having a directional component in the −Z direction) from the laterally outermost edge of first weir surface 264 towards first channel 252 until the first portion of the first glass flow of first molten glass 209 contacts (e.g., fuses with) the first portion of the second glass flow of second molten glass 210.

In aspects in which second molten glass 210 is flowed into first channel 252 and second channel 256 of second weir structure 240, the merging also comprises merging the second portion of the first glass flow of first molten glass 209 with the second portion of the second glass flow of second molten glass 210 on the second side in a second region disposed vertically between second weir surface 268 and fourth weir surface 276. For example, as shown in FIG. 7, the second portion of the first glass flow of first molten glass 209 flows from central channel 228, over second weir surface 268 of second sidewall portion 236, and then free-falls downwardly (e.g., in the −Z direction or having a directional component in the −Z direction) from the laterally outermost edge of second weir surface 268 towards second channel 256 until the second portion of the first glass flow of first molten glass 209 contacts (e.g., fuses with) the second portion of the second glass flow of second molten glass 210.

In aspects, one of first and second channels 252, 256 of the second weir structure can be delivered a third molten glass 211 that comprises a glass composition that is different than the glass compositions of first and second molten glasses 209, 210, such that the continuous laminate glass ribbon can have glass layers with up to three different glass compositions. In such aspects, the method comprises (i) flowing second molten glass 210 into first channel 252, (ii) flowing a third molten glass 211 into the second channel 256, (iii) passing second molten glass 210 over first sidewall 244 to merge with the second glass flow on first side 269 of forming body 200, (iv) passing third molten glass 211 over second sidewall 248 to merge with a third glass flow on second side 271 of forming body 200, and (v) merging the first and second portions of the first glass flow of first molten glass 209 with both the second glass flow of second molten glass 210 and the third glass flow of third molten glass 211 at draw line 216 to form continuous laminate glass ribbon 102 comprising three glass layers fused together.

Continuous laminate glass ribbon 102 can be drawn from draw line 216 by a pulling device (not shown) and can be passed to one or more downstream processes (not shown) for further processing continuous laminate glass ribbon 102. For example, continuous laminate glass ribbon 102 can be passed through an annealing furnace to anneal continuous laminate glass ribbon 102. Continuous laminate glass ribbon 102 can also be passed to a cutting and separating operation in which continuous laminate glass ribbon 102 can be separated into a plurality of laminate glass sheets.

In other aspects, glass forming apparatus 100 may comprise a forming body 400 that may be employed to produce continuous laminate glass ribbons 102 for making laminate glass sheets. Continuous laminate glass ribbons 102 and laminate glass sheets made therefrom may include a plurality of glass layers, such as 2, 3, 4, 5, 6, or more than 6 layers of glass. In some embodiments, continuous laminate glass ribbon 102 may include a core glass layer and at least two clad glass layers, where the core glass layer is disposed between the two clad glass layers. Each of the layers of glass may be fused together. In some embodiments, one or more of the glass layers may have a different glass composition than the other glass layers. The different glass compositions in the different glass layers may have different properties, such as coefficients of thermal expansion (CTE), Young's modulus, optical properties, chemical resistance, or other properties, which may provide certain features, such as improved strength, modified optical properties, or other features, to the laminated glass sheets produced from continuous laminate glass ribbons 102.

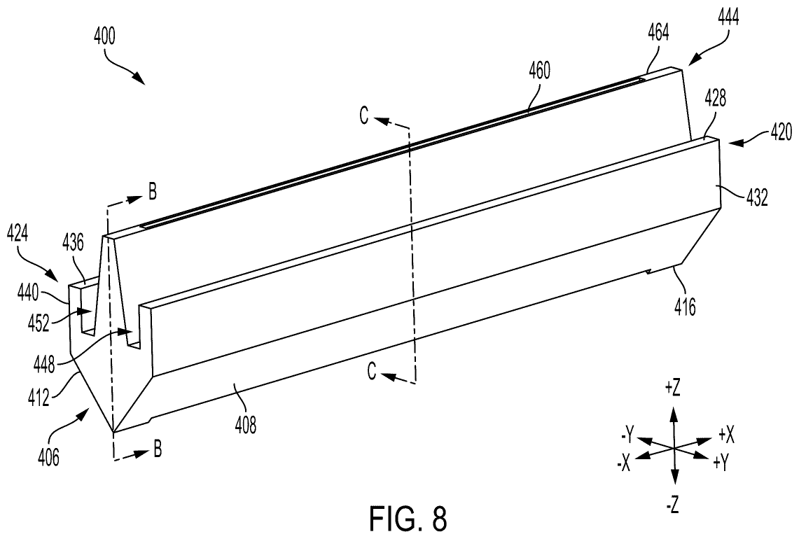

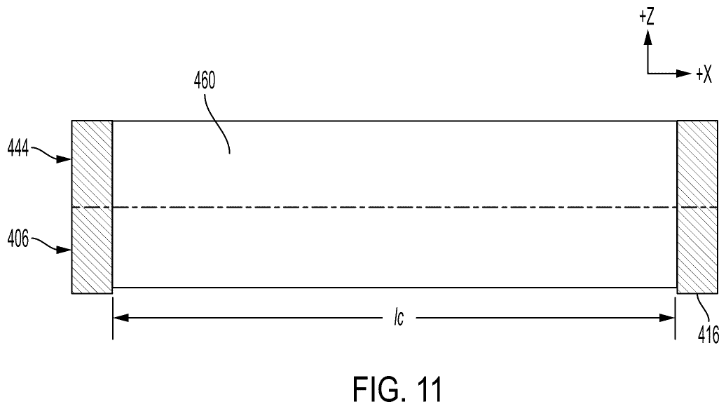

Referring now to FIGS. 8-12, forming body 400 comprises forming member 406 with a wedge-like cross-sectional shape that extends in a longitudinal direction (e.g., along the +/−X direction of the coordinate axis in FIGS. 8-12). Forming member 406 comprises first forming surface 408 and second forming surface 412 that converge downwardly (e.g., the forming surfaces extend with a directional component in the −Z direction) towards draw line 416 of the forming member. As used herein, the “draw line” includes the line along which first and second forming surfaces 408, 412 physically converge or intersect. For portions of first and second forming surfaces 408, 412 that do not physically converge or intersect (e.g., portions where conduit 460 passes through forming member 406, as described later in this disclosure), the “draw line” also includes the line along which these portions would converge if the (planar) forming surfaces proximate to these portions were projected downwardly until they physically converge or intersect. Such a projected draw line is depicted as a dashed line with reference number 416 in FIG. 10.

Forming body 400 further comprises a first sidewall 420 and a second sidewall 424 that extend upwardly (e.g., in the +Z direction or having a directional component in the +Z direction) from and longitudinally (e.g., in or substantially in the longitudinal direction) with forming member 406. First and second sidewalls 420, 424 are spaced apart from one another in a lateral direction (e.g., along the +/−Y direction of the coordinate axis in FIGS. 8-12) that is orthogonal to the longitudinal direction.

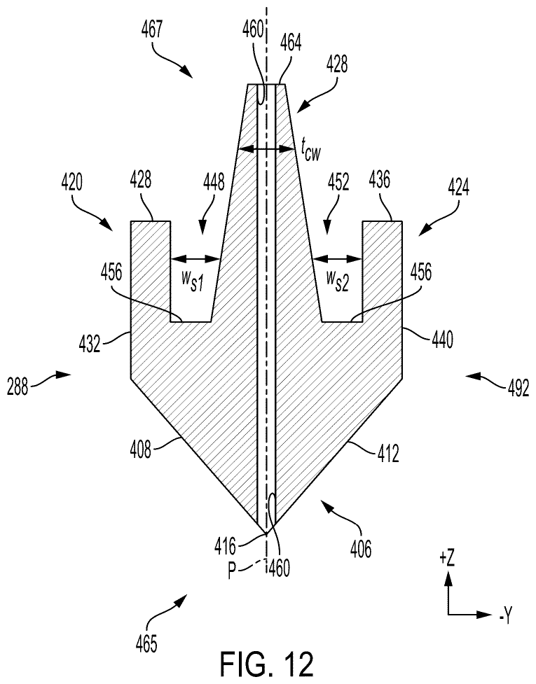

As best shown in FIGS. 8 and 12, first sidewall 420 comprises an uppermost portion that defines a first weir surface 428. First sidewall 420 also comprises first outer surface 432 that extends vertically (e.g., in or substantially in the vertical direction) and intersects first weir surface 428 at a first end and first forming surface 408 at a second end (e.g., opposed to the first end). Second sidewall 424 comprises an uppermost portion that defines a second weir surface 436. Second sidewall 424 also comprises a second outer surface 240 extending vertically and intersects second weir surface 436 at a first end and second forming surface 412 at a second end (e.g., opposed to the first end).

Forming body 400 further comprises central wall 444 that extends upwardly from and longitudinally with forming member 406. Central wall 444 is disposed between first and second sidewalls 420, 424 to define at least one channel portion 448, 452. In aspects, the at least one channel portion comprises a first channel portion 448 defined between first sidewall 420 and central wall 444. In aspects, the at least one channel portion (also or alternatively) comprises a second channel portion 452 defined between second sidewall 424 and the central wall. First and second channel portions 448, 452 are disposed above (e.g., vertically, directly above) forming member 406 such that forming member 406 defines bottom surface 456 of each of first and second channel portions 448, 452.

Forming body 400 further comprises conduit 460 extending through central wall 444 and forming member 406 in a vertical direction (e.g., along the +/−Z direction of the coordinate axis in FIGS. 8-12) that is orthogonal to the longitudinal and lateral directions. As shown in FIGS. 8, 10, 12, conduit 460 is configured to open from forming member 406 at bottom side 465 of forming body 400 and intersect draw line 416. Conduit 460 is also configured to open from upper surface 464 of central wall 444 at top side 467 of forming body 400. Conduit 460 is configured to receive first molten glass 409 from first glass delivery system 110 at top side 467 of forming body 400.

As shown in FIGS. 8-11, conduit 460 comprises a longest dimension, such as a length l_{c}, aligned with the longitudinal direction (e.g., the +/−X direction). Conduit 460 comprises a shortest dimension, such as a width w_{c}, aligned with the lateral direction (e.g., the +/−Y direction). In aspects, conduit 460 comprises a rectangular shape when viewed in a cross section oriented normal to the vertical direction (e.g., when viewed in the X-Z plane). In aspects, one or more of a size of conduit 460 or a cross-sectional shape of conduit 460 can be changed or set to satisfy different thickness ratios for the glass layers that will be distributed from forming body 400, as described later in this disclosure in connection with a method for forming laminated glass ribbon 102.

In aspects, as shown in FIG. 12, one or more of central wall 444 or conduit 460 can be laterally aligned with a draw plane P of forming body 400. Draw plane P generally bisects draw line 416 in the +/−Y directions of the coordinate axes depicted in FIG. 8-12 and extends in the vertically downward direction (e.g., −Z direction) and in the +/−X directions. In aspects, as shown in FIG. 12, central wall 444 comprises a thickness tew in the lateral direction that increases downwardly from upper surface 464 of central wall 444 to forming member 406. In aspects, thickness t_{cw} can be constant along central wall 444 between upper surface 464 and forming member 406. In aspects, as shown in FIGS. 8 and 12, upper surface 464 of central wall 444 is disposed higher in the vertical direction than first and second weir surfaces 428, 436.

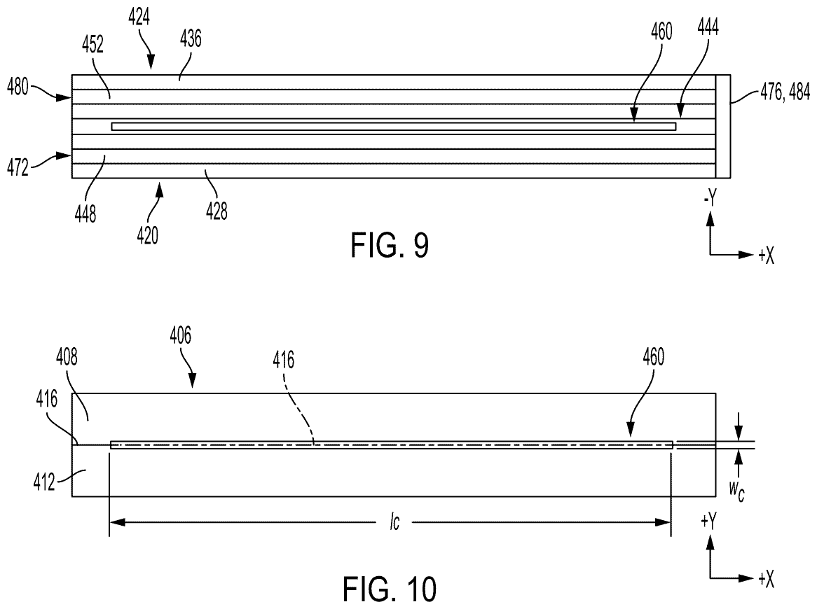

As shown in FIG. 12, first channel portion 448 comprises a first width wₛ₁ in the lateral direction, and second channel portion 452 comprises a second width wₛ₂ in the lateral direction. In some aspects, first and second widths wₛ₁, wₛ₂ are different. In other aspects, first and second widths wₛ₁, wₛ₂ are the same. When comparing dimensions of first and second channel portions 448, 452 (e.g., first and second widths wₛ₁, wₛ₂), the dimensions are measured from the same reference position for each feature. For example, the width of each channel portion can be measured perpendicularly from a position on an inner surface of the sidewall that is (i) a specific distance in the vertical direction from a first reference feature or surface (e.g., bottom surface 456) and (ii) a specific distance in the longitudinal direction from a second reference feature or surface (e.g., end dam 476 of forming body 400, as shown in FIG. 9). In aspects, first and second widths wₛ₁, wₛ₂ can be constant or variable in one or more directions.

In aspects, as shown in FIG. 9, first channel portion 448 comprises first inlet 472 (e.g., a first inlet end or side) and first end dam 476 spaced apart from first inlet 472 in the longitudinal direction. First inlet 472 and first end dam 476 bound first channel portion 448 in the longitudinal direction, first sidewall 420 and central wall 444 bound first channel portion 448 in the lateral direction, and bottom surface 456 defined by forming member 406 bounds first channel portion 448 in the downward direction (e.g., −Z direction) such that molten glass delivered to first channel portion 448 moves upwardly within (e.g., fills) first channel portion 448 and flows over first weir surface 428 and down first outer surface 432.

In aspects, as shown in FIG. 9, second channel portion 452 comprises a second inlet 480 (e.g., a second inlet end or side) and a second end dam 484 spaced apart from second inlet 480 in the longitudinal direction. First inlet 480 and first end dam 484 bound second channel portion 252 in the longitudinal direction, second sidewall 424 and central wall 444 bound second channel portion 452 in the lateral direction, and bottom surface 456 defined by the forming member 406 bounds second channel portion 452 in the downward direction (e.g., −Z direction) such that molten glass delivered to the second channel portion 452 moves upwardly within (e.g., fills) second channel portion 452 and flows over second weir surface 436 and down second outer surface 440.

In aspects, as shown in FIG. 9, first and second inlets 472, 480 can be disposed at a first (same) end of forming body 400, and first and second end dams 476, 484 can be disposed on a second (same) end of forming body 400. In such aspects, first and second channel portions 448, 452 can be configured to receive molten glass from the same glass delivery system and/or receive the same composition of molten glass from the same glass delivery system. In such aspects, first and second end dams 476, 484 can be configured as a common end dam, as depicted in FIG. 9.

In aspects, first and second inlets 472, 480 can be disposed at different ends of forming body 400, and first and second end dams 476, 484 can be disposed at different ends of the forming body. For example, first inlet 472 can be disposed at the first end and second inlet 480 can be disposed at the second end. Similarly, first end dam 476 can be disposed at the second end and second end dam 484 can be disposed at the first end. In such aspects, first and second channel portions 448, 452 can be configured to received molten glass from different glass delivery systems and/or receive different compositions of molten glass from the different glass delivery systems.

The various features of forming body 400 described herein can be constructed of a refractory metal capable of withstanding the temperatures experienced during formation of continuous laminate glass ribbon 102 without degrading or reacting with the constituents of first molten glass 409 or second molten glass 410. The refractory metal can be platinum, platinum alloy, or other metals or metal alloys. In aspects, one or more of forming member 406, first and second sidewalls 420, 424, and central wall 444 can be platinum or a platinum-alloy. First and second channel portions 448, 452 and conduit 460 can also be platinum or a platinum-alloy since these features can be defined by forming member 406, first and second sidewalls 420, 424, and/or central wall 444. All-platinum or platinum alloy surfaces of forming body 400 can reduce or prevent compatibility issues between the glass compositions and refractory materials used for overflow-style forming bodies.

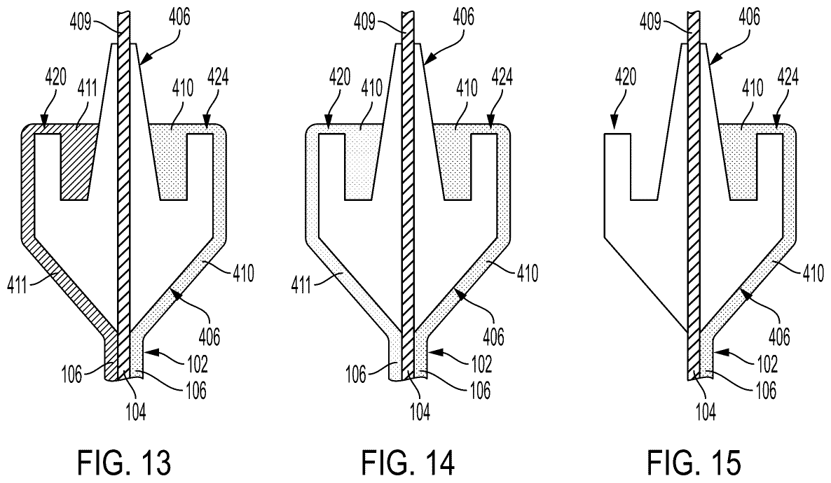

A method for forming a laminated glass ribbon having a plurality of glass layers is now described with reference to FIGS. 13-15, which illustrate different configurations of molten glass that can be distributed from forming body 400 of FIGS. 8-12. The method comprises flowing first molten glass 409 into conduit 460 of forming body 400. As previously described with reference to FIG. 1, first molten glass 409 can be produced in first molten glass system 110 (FIG. 1) and delivered to conduit 460 via one of inlets 402, 404 to forming body 400.

As previously described with reference to FIGS. 8-12, forming body 400 comprises a forming member 406 that extends in a longitudinal direction (e.g., +/−X direction) and a central wall 444 that extends upwardly from and longitudinally with forming member 406. Conduit 460 extends through central wall 444 and forming member 406 in a vertical direction (e.g., +/−Z direction) orthogonal to the longitudinal direction and opens from forming member 406 so as to intersect a draw line 416 of the forming member 406. Conduit 460 comprises a longest dimension, such as a length l_{c}, aligned with the longitudinal direction. As shown in FIGS. 13-15, first molten glass 409 can be flowed into first conduit 460 at top side 467 of forming body 400.

The method further comprises passing first molten glass 409 through conduit 460 to merge with a first glass flow at bottom side 465 of forming body 400. As shown in FIGS. 13-15, the first glass flow of first molten glass 409 extends downwardly (e.g., −Z direction) away from conduit 460 and passes through draw line 416 of forming member 406.

While first molten glass 409 is flowed into and passed through conduit 460, the method further comprises flowing second molten glass 410 into at least one channel portion 448, 452 of forming body 400. As previously described with reference to FIG. 1, second molten glass 210 can be produced in second molten glass system 150 (FIG. 1) and delivered to the at least one channel 448, 452 via one of inlets 402, 404 to forming body 400.

As previously described with reference to FIGS. 8-12, forming body 400 comprises a pair of sidewalls (e.g., the first and second sidewalls 420, 424) that extend upwardly from and longitudinally with forming member 406. Sidewalls 420, 424 are spaced apart from one another in a lateral direction (e.g., +/−Y direction) that is orthogonal to the longitudinal and vertical directions. Central wall 444 is disposed between sidewalls 420, 424 to define the at least one channel portion 448, 452.

The method further comprises passing second molten glass 410 over at least one of sidewalls 420, 424 to merge with a second glass flow on first side 488 (FIG. 12) of forming body 400, second side 492 (FIG. 12) of the forming body, or both. As shown in FIGS. 13-15, the second glass flow of second molten glass 410 flows from the at least one channel portion (e.g., first channel portion 448 and/or second channel portion 452 shown in FIGS. 8-12), over at least one of the weir surfaces of sidewalls 420, 424 (e.g., first and second weir surfaces 428, 436 shown in FIGS. 3-7), downwardly along at least one of the outer surfaces of sidewalls 420, 424 (e.g., first and second outer surfaces 432, 440), and downwardly along at least one of the forming surfaces of forming member 406 (e.g., the first and second forming surfaces 408, 412).

While first molten glass 409 is flowed into and passed through conduit 460 and second molten glass 410 is flowed into the at least one channel portion 448, 452 and passed over the at least one of the sidewalls 420, 424, the method further comprises merging the second glass flow with the first glass flow to form continuous laminate glass ribbon 102 comprising a plurality of glass layers 104, 106 fused together. For example, upon contact at or proximate draw line 416, the flow of second molten glass 410 may fuse to the flow of first molten glass 409. The flow of first molten glass 409 can form core layer 104 of continuous laminate ribbon 102. The flow(s) of second molten glass 410 can form one or more clad layers 106 of continuous laminate glass ribbon 102. In aspects, core layer 104 of first molten glass 409 can be disposed between two clad layers 106 of second molten glass 410, as shown in FIGS. 13 and 14. In aspects, first molten glass 409 comprises a glass composition different from a glass composition of second molten glass 410, as depicted in each of FIGS. 13-15 by using different hatch patterns for first and second molten glasses 409, 410. In aspects, first and second molten glasses 409, 410 can have the same composition (not shown).

In aspects, the at least one channel portion comprises first channel portion 448 (FIG. 7) defined between first sidewall 420 of the pair of sidewalls 420, 424 and central wall 444 and a second channel portion 452 (FIG. 12) defined between second sidewall 424 of the pair of sidewalls 420, 424 and central wall 444.

In aspects, as shown in FIG. 14, the method further comprises flowing second molten glass 410 into both first channel portion 448 and second channel portion 452, passing second molten glass 410 over first sidewall 420 to merge with a first portion of the second glass flow on first side 488 (FIG. 12) of forming body 400, passing second molten glass 410 over second sidewall 424 to merge with a second portion of second glass 410 flowing on second side 492 (FIG. 12) of forming body 400, and merging flowing first molten glass 409 with both the first portion of the flow of second molten glass 410 (e.g., on first side 488 of forming body 400) and the second portion of the flow of second molten glass 410 (e.g., on second side 492 of the forming body 400) at (or proximate) draw line 416 to form continuous laminate glass ribbon 102 comprising three glass layers fused together.

In aspects, as shown in FIG. 13, the method further comprises flowing second molten glass 410 into first channel portion 448, flowing third molten glass 411 into second channel portion 452, passing second molten glass 410 over first sidewall 420 to merge with the second glass flow on first side 488 (FIG. 12) of forming body 400, passing third molten glass 411 over second sidewall 424 to merge with a third glass flow on second side 492 of forming body 400, merging the first glass flow (e.g. comprising the first molten glass 409) with both the second glass flow (e.g., comprising the second molten glass 410) and the third glass flow (e.g., comprising third molten glass 411) at (or proximate) draw line 416 to form continuous laminate glass ribbon 102 comprising three glass layers fused together. In such aspects as shown in FIG. 13, first molten glass 409 can have a glass composition different from a glass composition of second molten glass 410, and third molten glass 411 can have a glass composition different from the glass compositions of first and second molten glasses 409, 410.

Continuous laminate glass ribbon 102 can be drawn from draw line 416 by a pulling device (not shown) and can be passed to one or more downstream processes (not shown) for further processing of continuous laminate glass ribbon 102. For example, continuous laminate glass ribbon 102 can be passed through an annealing furnace to anneal continuous laminate glass ribbon 102. Continuous laminate glass ribbon 102 can also be passed to a cutting and separating operation in which continuous laminate glass ribbon 102 can be separated into a plurality of laminate glass sheets.

Embodiments of the forming bodies, the glass forming apparatus, and methods of forming laminated glass ribbons described herein have numerous advantages. The glass forming apparatus with forming bodies disclosed herein does not require a second forming body such that fabrication will be limited to only one refractory body for the glass forming apparatus unlike existing laminate fusion draw machines (LFDM). Thus, the glass forming apparatus with forming bodies disclosed herein can eliminate the cost of fabricating the upper (clad) forming body and the muffle surrounding the forming body can be significantly reduced. Furthermore, there will be a reduction in total weight due to elimination of the upper (clad) forming body, further reducing the cost of fabricating the enclosure and/or muffle. Additionally, improved properties could be achieved since the same materials will be utilized in the production of the (monolithic) forming bodies. Further cost saving can be realized from the reduction of energy required to heat the unit since there is less material of the forming body to heat. As such, operating costs are reduced as well.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A forming body for forming laminated glass sheets, comprising:
a forming member extending in a longitudinal direction and comprising a first forming surface and a second forming surface converging downwardly along a draw line of the forming member;
a first weir structure comprising a central wall extending upwardly from and longitudinally with the forming member, the central wall comprising a central channel opening upwardly in a vertical direction orthogonal to the longitudinal direction and extending longitudinally between first and second sidewall portions of the central wall; and
a second weir structure comprising first and second sidewalls extending upwardly from and longitudinally with the forming member, the first and second sidewalls spaced apart from one another in a lateral direction orthogonal to the longitudinal and vertical directions, the central wall disposed between the first and second sidewalls to define (i) a first channel between the first sidewall and the central wall and (ii) a second channel between the second sidewall and the central wall.

2. The forming body of claim 1, wherein one or more of the central wall or the central channel are laterally aligned with a draw plane of the forming body.

3. The forming body of claim 2, wherein:
uppermost portions of the first and second sidewall portions of the first weir structure define first and second weir surfaces, respectively,
uppermost portions of the first and second sidewalls of the second weir structure define third and fourth weir surfaces, respectively, and
the first and second weir surfaces are disposed higher in the vertical direction than the third and fourth weir surfaces.

4. The forming body of claim 3, wherein the first and second weir surfaces are disposed laterally inwardly from the third and fourth weir surfaces.

5. The forming body of claim 3, wherein the central wall comprises a thickness in the lateral direction that decreases from the first and second weir surfaces to the forming member.

6. The forming body of claim 3, wherein the first weir surface of the first weir structure comprises a laterally outermost edge overhanging the first channel of the second weir structure when viewed in the vertical direction.

7. The forming body of claim 3, wherein the second weir surface of the first weir structure comprises a laterally outermost edge overhanging the second channel of the second weir structure when viewed in the vertical direction.

8. The forming body of claim 3, wherein each of the first and second channels comprises a bottom surface defined by the forming member.

9. The forming body of claim 8, wherein the central wall comprises a first outer surface extending between the first weir surface and the bottom surface of the first channel, and a first angle between the first outer surface and the bottom surface is less than 90°.

10. The forming body of claim 8, wherein the central wall comprises a second outer surface extending between the second weir surface and the bottom surface of the second channel, and a second angle between the second outer surface and the bottom surface is less than 90°.

11. The forming body of claim 1, wherein the first sidewall comprises a third outer surface intersecting the first forming surface, and the second sidewall comprises a fourth outer surface intersecting the second forming surface.

12. The forming body of claim 1, wherein the first and second channels comprise first and second widths, respectively, in the lateral direction, and the first and second widths are different.

13. The forming body of claim 1, wherein the first and second channels comprise first and second widths, respectively, in the lateral direction, and the first and second widths are the same.

14. The forming body of claim 1, wherein each of the first and second channels comprises an inlet and an end dam spaced apart from one another in the longitudinal direction.

15. The forming body of claim 14, wherein the inlets and the end dams of the first and second channels are disposed, respectively, at the same end of the forming body.

16. The forming body of claim 14, wherein the inlets and the end dams of the first and second channels are disposed, respectively, at opposite ends of the forming body.

17. A glass forming apparatus, comprising:
the forming body of claim 1;
a first glass delivery system in fluid communication with an inlet of the central channel; and
a second glass delivery system in fluid communication with an inlet of the first channel, the second channel, or both.

18. A method for forming a laminated glass ribbon comprising a plurality of glass layers, comprising:
flowing a first molten glass into a central channel of a first weir structure of a forming body, the forming body comprising a forming member extending in a longitudinal direction, the first weir structure comprising a central wall extending upwardly from and longitudinally with the forming member, the central wall comprising the central channel configured to open upwardly in a vertical direction orthogonal to the longitudinal direction and extending longitudinally between first and second sidewall portions of the central wall;
passing the first molten glass over (i) the first sidewall portion to merge with a first portion of a first glass flow on a first side of the forming body and (ii) the second sidewall portion to merge with a second portion of the first glass flow on a second side of the forming body;
flowing a second molten glass into at least one channel of a second weir structure of the forming body, the second weir structure comprising a pair of sidewalls extending upwardly from and longitudinally with the forming member and spaced apart from one another in a lateral direction orthogonal to the longitudinal and vertical directions, the central wall disposed laterally between the pair of sidewalls to define the at least one channel;
passing the second molten glass over the at least one channel to merge with a second glass flow on a first side of the forming body, a second side of the forming body, or both;
merging the second glass flow with the first glass flow to form a continuous laminate glass ribbon comprising a plurality of glass layers fused together; and
drawing the continuous laminate glass ribbon downward from a draw line of the forming member.

19. The method of claim 18, wherein the merging comprises merging the first glass flow with the second glass flow at the draw line.

20. The method of claim 18, wherein the first molten glass comprises a glass composition different from a glass composition of the second molten glass.

21. The method of claim 18, wherein the second glass flow forms a core glass, and the first glass flow forms a clad glass.

22. The method of claim 18, wherein the at least one channel comprises (i) a first channel defined between a first sidewall of the pair of sidewalls and the central wall and (ii) a second channel defined between a second sidewall of the pair of sidewalls and the central wall.

23. The method of claim 22, further comprising:
flowing the second molten glass into the first channel and the second channel;
passing the second molten glass over the first sidewall to merge with a first portion of the second glass flow on the first side of the forming body;
passing the second molten glass over the second sidewall to merge with a second portion of second glass flow on the second side of the forming body; and
merging the first and second portions of the first glass flow with the first and second portions of the second glass flow at the draw line to form the continuous laminate glass ribbon comprising three glass layers fused together.

24. The method of claim 22, further comprising:
flowing the second molten glass into the first channel;
flowing a third molten glass into the second channel;
passing the second molten glass over the first sidewall to merge with the second glass flow on the first side of the forming body;
passing the third molten glass over the second sidewall to merge with a third glass flow on the second side of the forming body;
merging the first and second portions of the first glass flow with both the second glass flow and the third glass flow at the draw line to form the continuous laminate glass ribbon comprising three glass layers fused together,
wherein the first molten glass comprises a glass composition different from a glass composition of the second molten glass, and the third molten glass comprises a glass composition different from the glass compositions of the first and second molten glasses.

25. The method of claim 18, wherein:
uppermost portions of the first and second sidewall portions of the first weir structure define first and second weir surfaces, respectively,
uppermost portions of the first and second sidewalls of the second weir structure define third and fourth weir surfaces, respectively, and
the first and second weir surfaces are disposed higher in the vertical direction than the third and fourth weir surfaces.
